(19) United States
(12) Patent Application Publication
(10) Pub. No.: US 2026/0148642 A1
(43) Pub. Date: May 28, 2026

(54) RUNWAY CONFIGURATION PREDICTION SYSTEM AND METHOD

(71) Applicant: THE BOEING COMPANY, Arlington, VA (US)

(72) Inventors: Pawel Zarzycki, Richmond (CA); Mo Zhou, Richmond (CA); William Jenden, Richmond (CA); Xu Xia Zhong, Richmond (CA)

(73) Assignee: THE BOEING COMPANY, Arlington, VA (US)

(21) Appl. No.: 18/959,768

(22) Filed: Nov. 26, 2024

(51) Int. Cl. G08G 5/00

(52) U.S. Cl. CPC G08G 5/22; G08G 5/727

(57) ABSTRACT

An application-specific integrated circuit for an artificial neural network includes: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive historical configurations of runways for an airport; receive weather forecasts for the airport over an extended forward prediction window; and predict future configurations of the runways for each of several prediction intervals within the forward prediction window and over an entirety of the forward prediction window.

### FIELD OF THE DISCLOSURE

Examples of the present disclosure relate to predicting the configurations of runways at airports.

### BACKGROUND OF THE DISCLOSURE

Predicting active runway configurations at airports can be a complex task due to various factors that can influence runway selection. Additionally, runway configurations can change frequently based on conditions, making accurate predictions challenging. Some known runway prediction solutions use a standard time-series modelling approach. Drawbacks to these solutions include limited predictive power, especially for longer forward time windows (e.g., longer than twelve hours). Another common problem is that predictions may be unstable over time. For example, a runway may be predicted to be on or available, then off or unavailable, then on or available again in quick session within the same prediction or over successive predictions. As another example, a runway may be predicted to have an impossible configuration (e.g., opposite ends of the same runway in simultaneous use for aircraft arrivals or departures).

### SUMMARY OF THE DISCLOSURE

In one example, an application-specific integrated circuit (ASIC) for an artificial neural network (ANN) is provided. The ASIC includes: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive historical configurations of runways for an airport; receive weather forecasts for the airport over an extended forward prediction window; and predict future configurations of the runways for each of several prediction intervals within the forward prediction window and over an entirety of the forward prediction window.

In another example, a method is provided that includes receiving historical configurations of runways for an airport into an ANN having at least one ASIC having neurons organized in an array, each of the neurons including a register, a processing element, and at least one input, and the ASIC having synaptic circuits, each of the synaptic circuits including a memory for storing a synaptic weight, wherein each of the neurons is connected to at least one other of the neurons via at least one of the synaptic circuits; receiving weather forecasts for the airport over an extended forward prediction window into the ANN; and using the ANN to predict future configurations of the runways for each of several prediction intervals within the forward prediction window and over an entirety of the forward prediction window.

In another example, an ASIC for an ANN is provided. The ASIC includes neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive historical configurations of runways for an airport; receive airport constraints on usage of the runways; receive weather forecasts for the airport over an extended forward prediction window of longer than twelve hours; and predict future configurations of the runways for each of several prediction intervals that are less than sixty minutes and within the forward prediction window and over an entirety of the forward prediction window.

### BRIEF DESCRIPTION OF THE DRAWINGS

FIG. 1 illustrates one example of a runway prediction system;

FIG. 2 illustrates one example of an airport;

FIG. 3 schematically illustrates one example of the ANN shown in FIG. 1 encoding historical and predicted information for predicting runway configurations;

FIG. 4 illustrates one example of the ANN shown in FIG. 1;

FIG. 5 illustrates performance metrics of different prediction models for predicting runway configurations; and

FIG. 6 illustrates a flowchart of one example of a method for predicting runway configurations.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

One or more examples of the inventive subject matter described herein provide runway configuration prediction systems and methods that can predict configurations of runways over a long forward window (e.g., twenty-four hours or longer) using a deep learning-based artificial intelligence or machine learning system using historical runway configuration data and meteorological reports. The systems and methods can provide detailed runway configuration predictions in a dense manner by predicting the configuration of each runway at frequent intervals (e.g., every fifteen minutes). For example, the systems and methods can predict what the runway configuration will be every fifteen minutes over the forward window. The systems and methods can make these predictions accurately, quickly (e.g., the prediction for the entire forward window is performed in less than a second), and can be agnostic as to airport layouts (e.g., different numbers of runways).

The runway configurations at airports can be predicted in spite of a large number of factors influencing the configurations. These factors can include weather conditions, wind direction and speed, air traffic volume, aircraft size and weight, noise abatement procedures, and airport operational constraints. Additionally, the systems and methods can predict the runway configurations at frequent intervals to address runway configurations frequently changing. The prediction systems and methods described herein can effectively analyze and interpret these factors to provide more accurate predictions of which runways will be in use, while avoiding inconsistent or impossible configuration predictions, as well as whether the runways are configured for aircraft arrivals or departures, and the direction in which aircraft are permitted to arrival or depart along the runways. The predictions output by the systems and methods can be used to create runway-to-runway flight plans and select appropriate procedures, by pilots to allow early briefing of departure and arrival procedures, and as input to other systems and algorithms such as congestion estimators, an aircraft-runway assignment algorithm or a taxi duration predictor.

The prediction systems and methods can provide increased prediction accuracy, along with increased precision and recall throughout the forward forecast window. The systems and methods may utilize a limited memory footprint, which allows for massive parallelism in a production environment. The systems and methods also provide very low prediction latency, which allows production deployment scenarios that require real-time performance.

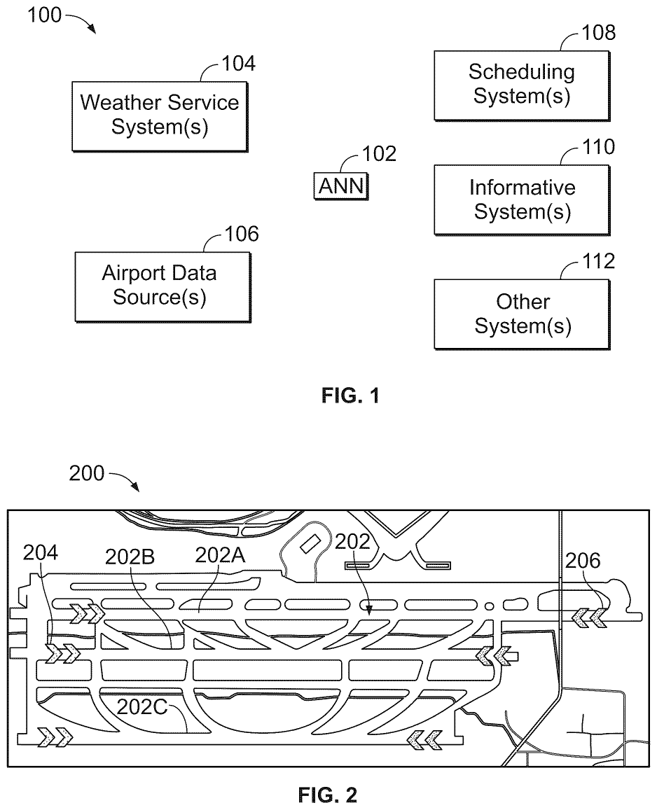

FIG. 1 illustrates one example of a runway prediction system 100. The runway prediction system 100 includes an artificial neural network (ANN) 102, which can represent one or more application-specific integrated circuits (ASIC), as described below. The ANN 102 can be trained to predict runway configurations over an extended forward prediction window at frequent prediction intervals. The forward prediction window is the time period over which the runway configurations are predicted. The prediction intervals are the time periods between prediction instances. For example, for a runway, the configuration of that runway can be predicted over a forward prediction window of twenty-four hours with the configuration predicted for every fifteen minutes over that forward prediction window. This means that the runway configuration can be predicted to be active, arrival, and first direction at time 00:00; active, arrival, first direction at time 00:15 (i.e., fifteen minutes after time 00:00); inactive at time 00:30; active, departure, first direction at time 00:45; and so on. This prediction indicates that from time 00:00 to 00:30, the runway configuration will be active for arrivals in the first direction, from time 00:30 to 00:45, the runway configuration will be inactive (no arrivals or departures allowed), and from time 00:45 to at least 01:00, the runway configuration will be active for departures along the first direction, and so on. The ANN 102 can predict the configurations of several runways at an airport quickly (e.g., within one second), and can repeatedly predict the configurations over time to provide the most up-to-date, accurate, and precise predictions.

With continued reference to the prediction system 100 shown in FIG. 1, FIG. 2 illustrates one example of an airport 200. The airport 200 can include several runways 202 (e.g., 202A-C). Each of these runways 202 can be identified by a number or another identifier. The configuration of each runway 202 can include active or inactive, arrival or departure, and a direction 204, 206. A runway 202 that is configured as active is available for aircraft to land or depart, while a runway 202 that is configured as inactive is not available for arrival or departure. A runway 202 that is configured as arrival can accept aircraft for landings but not departures. A runway 202 configured as departure can accept aircraft for departures but not landings. The direction 204, 206 of a runway 202 indicates which direction 204 or 206 that aircraft are allowed to arrive or depart using the runway. Therefore, if runway 202A is configured as active, departure, direction 206 over a first prediction interval, this means that the runway 202A is predicted to be configured for departures along the direction 206, but not for arrivals in any direction, and not for arrivals or departures along the direction 204 over the prediction interval.

The ANN 102 can receive input data from a variety of data sources, such as weather service systems 104, airport data sources 106, and the like. The weather service systems 104 can be weather forecasting systems that provide weather forecasts for different areas, including the airport for which the predictions are being made. For example, the weather service systems 104 can represent the Terminal Aerodrome Forecasts (TAFs), the National Weather Service (NWS), the American Meteorological Society, AccuWeather, Inc., the National Weather Association, or the like. The TAFs include weather forecasts specifically for the areas around airports. The TAFs can provide predictions for significant weather conditions, including wind, visibility, precipitation, and cloud cover, typically covering a twenty-four to thirty hour period. TAFs are issued at regular intervals (usually every six hours) and include specific time frames for expected weather changes. The format can include coded information indicating forecasted weather conditions, thereby making the forecasts concise and standardized for pilots and other end users. Pilots can use TAFs to plan flights and make informed decisions regarding takeoff, landing, and in-flight operations. TAFs can be generated and disseminated by national meteorological services or aviation authorities. In the United States, for example, the NWS is responsible for producing TAFs. TAFs can be sent out via various channels, including: aviation weather websites (where pilots can access the TAFs through the websites), NOTAMs (notices to airmen) can include TAFs and provide important information to pilots, flight planning software that integrate TAFs for easy access to users, air traffic control (ATC) can communicate TAFs during pre-flight briefings, or the like.

The weather service systems 104 can provide weather forecasts for the airport for different times (e.g., for each hour) that extend over the forward prediction window. These weather forecasts can include predicted precipitation (e.g., type and amount), wind direction, wind speed, visibility distances, cloud levels, or the like.

The airport data sources 106 can be the airports themselves or other systems within or connected with the airports that can provide information useful to the ANN 102 for making the runway configuration predictions. This information can include, for example, anticipated or scheduled air traffic volume at or around the airport, the size and weight of different aircraft anticipated or scheduled to be on different runways at different times at the airport, noise abatement procedures or limitations placed on the airport, airport operational constraints (e.g., number of personnel available for baggage handling, working gates of the airport, air traffic control, etc.). This information can be referred to as runway configuration constraints, as this information can indicate limits on capacities and availabilities for the runways at the airport.

Additionally, the data sources 104, 106 can provide historical data. For example, the weather service systems 104 can provide records of prior weather conditions at the airport, such as the precipitation (e.g., type and amount) that previously occurred, previously measured wind directions, previously measured wind speeds, previously measured visibility distances, previously measured cloud levels, etc., along with the dates and/or times at which these weather conditions previously occurred and/or were measured. The airport data sources 106 can provide historical data on the runway configurations and runway configuration constraints. This historical data can inform the ANN 102 of how each runway was configured at different times in the past.

The ANN 102 can receive this historical information (e.g., former weather conditions, constraints, and runway configurations) and predicted information or information about the future (e.g., predicted weather conditions, upcoming constraints on the airport, etc.). The ANN 102 can uniquely encode this information to assist in predicting runway configurations.

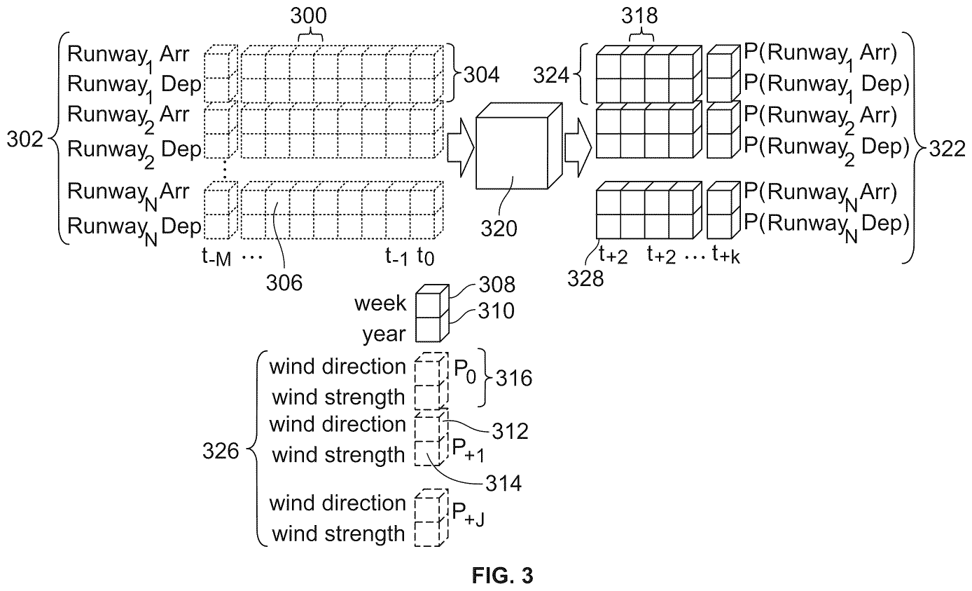

FIG. 3 schematically illustrates one example of the ANN 102 shown in FIG. 1 encoding historical and predicted information for predicting runway configurations. The ANN 102 can divide up the historical information into time bins 300, with each past time bin 300 representing a different span of time in the past. As one example, each past time bin 300 can represent a fifteen minute span in the past. The past time bin 300 associated with t₀ can represent the prior fifteen minutes, the past time bin 300 associated with t₋₁ can represent the fifteen minutes prior to the past time bin 300 associated with t₀, the past time bin 300 associated with t₋₂ can represent the fifteen minutes prior to the past time bin 300 associated with t₋₁, and so on.

Historical runway configuration data 302 can be associated with the different past time bins 300. The historical runway configuration data 302 represents the configuration of each runway during each of the different past time bins 300. Different runway sets 304 of the historical runway configuration data 302 represent the configurations of the different runways at the airport. For example, the set 304 associated with Runway₁Arr and Runway₁Dep includes the historical configuration data 302 for a first runway, the set 304 associated with Runway₂Arr and Runway₂Dep includes the historical configuration data 302 for a second runway, and so on.

The historical runway configuration data 302 in each of the runway sets 304 also can be divided up into different past time bins 300. For example, each box 306 in FIG. 3 can represent the historical runway configuration data 302 for one runway during the prior time period associated with the corresponding past time bin 300. The runway sets 304 can include two data entries, or boxes 306, to indicate the arrival or departure configuration for that runway. For example, a value of one in the Runway₂Arr box 306 during the time bin 300 associated with t₋₁ and a value of zero in the Runway₂Dep box 306 during the time bin 300 associated with t₋₁ indicate that the second runway at the airport was configured for arrivals during the prior time period represented by the time bin 300 associated with t₋₁ (e.g., between fifteen minutes and thirty minutes ago). Optionally, the data entries, or boxes 306, for a runway and in different time bins 300 can represent or include the direction configuration of the runway during that time period (e.g., the direction in which aircraft were allowed to move along that runway during that time period) and/or the constraints on the airport or runway during that time period.

Historical weather condition information optionally can be associated with different time bins 300. This historical weather condition information can include prior weather conditions at the airport during the different past time bins 300, such as over different weeks 308 and/or years 310. Additionally, the ANN 102 can encode weather forecasts 326 by separating predicted wind directions 312 and wind strengths (e.g., wind speeds) 314 according to different sources. For example, each weather service system 104 can provide a different set 316 of weather forecasts for the airport over one or more future time bins 318. Similar to the past time bins 300, each of the future time bins 318 can represent a time period in the future, such as every fifteen minutes into the future.

The historical weather condition information, historical runway configurations, and the predicted weather conditions can then be put into a neural network or machine learning model 320 of the airport. This model 320 may be encoded in the weights and synaptic circuits within the ANN 102, as described herein. The model 320 may be trained or created from prior runway configurations and the corresponding weather conditions, as described herein. The model 320 can receive the historical weather condition information, the historical runway configurations, and the predicted weather conditions, and then output predicted runway configuration data 322.

Similar to the historical runway configuration data 302, the predicted runway configuration data 322 can be encoded into different runway sets 324 that are, in turn, divided into the different future time bins or intervals 318. For example, each box 328 in FIG. 3 can represent the predicted runway configuration data 322 for one runway during the future time period or interval associated with the corresponding future time bin 318. The runway sets 324 can include two data entries, or boxes 328, for each future time interval 318 to indicate the arrival or departure configuration for that runway, and optionally the direction, as described above.

This data 322 can be output to and used by one or more systems as shown in FIG. 1, such as scheduling systems 108 that generate flight schedules for aircraft and/or airports, informative systems 110 that provide the predictions to aid in planning flights, and/or other systems 112 that can use the predictions for various purposes. For example, the predictions can be used to create runway-to-runway flight plans and select appropriate procedures, by pilots to allow early briefing of departure and arrival procedures, and as input to other systems and algorithms such as congestion estimators, an aircraft-runway assignment algorithm or a taxi duration predictor.

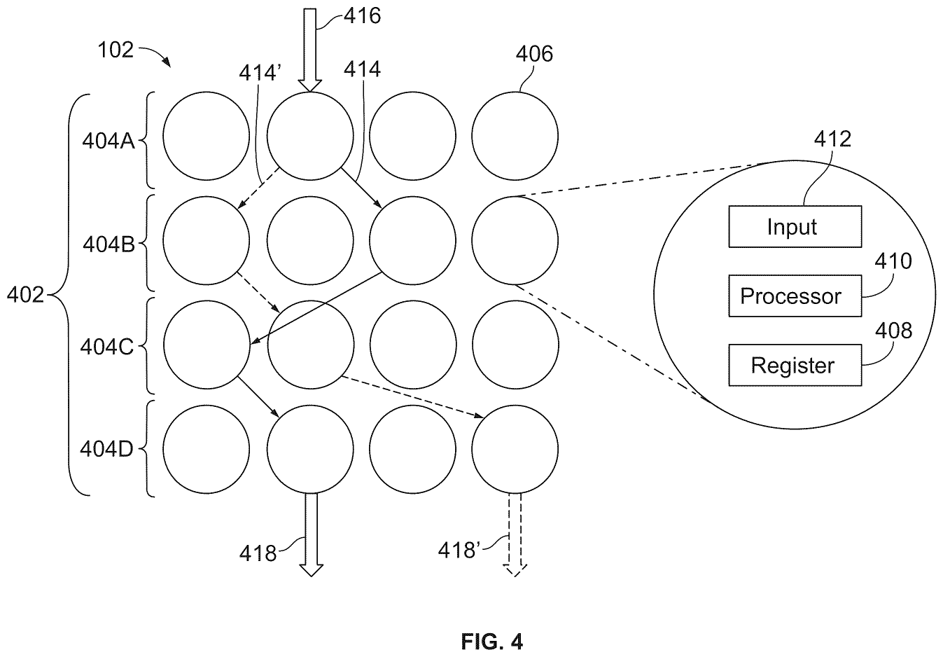

FIG. 4 illustrates one example of the ANN 102. The ANN 102 can includes a series 402 of layers 404A-D, each comprising one or more artificial neurons 406 arranged in one or more neuron arrays or arrangements. While four neurons 406 are shown in each layer 404A-D and four layers 404A-D are shown, alternatively, a different number of neurons 406 may be in one or more of the layers 404A-D and/or there may be a different number of layers 404A-D.

The ANN 102 may include the neurons 406 arranged in an input layer 404A, an output layer 404D, and two or more fully connected hidden or intermediate layers 404B, 404C between the input and output layers 404A, 404D. Each neuron 406 can include or represent a register 408, a microprocessor 410, and at least one input 412. The neurons 406 can generate outputs based on one or more activation functions. The neurons 406 can receive input from another neuron 406 (e.g., the output from one neuron 406 can be the input for another neuron 406). This input also can include a set of weights. The neurons 406 can be connected with each other via synaptic circuits 414, 414′. The synaptic circuits 414, 414′ can include or represent memories for storing synaptic weights.

One or more neurons 406 in the input layer 404A of the ANN 102 can receive an input 416 into the ANN 102. These neurons 406 can receive this input via the input(s) 412 of those neurons 406 in the input layer 404A. The neurons 406 receive the input, apply one or more mathematical equations or relationships stored in the registers 408 (and that include the weights) to generate an output. The processors 410 of the neurons 406 apply the equations/relationships and can pass the output to another neuron 406 in the same layer 404A or in a different layer 404B, 404C. The output from one neuron 406 is passed along a synaptic circuit 414 to another neuron 406 and is used as input to this other neuron 406. This process continues until one or more neurons 406 in the output layer 404D generate an output 418 from the ANN 102. The synaptic circuits 414, 414′, weights stored in the synaptic circuits 414, 414′, and/or the mathematical relationships between the neurons 406 can define the model 320 that is used to predict the runway configurations (e.g., the data 322).

During training of the ANN 102, labeled data may be provided as input 416 to the ANN 102. This labeled data can be encoded similar to as described above in connection with FIG. 3. The labeled data can include prior weather conditions, prior airport constraints, and prior runway configurations 302 (e.g., for prior time intervals associated with the past time bins 300) for a first past time period. The neurons 406 process the input data as described above to generate the training output of the ANN 102. This training output can be the predicted runway configurations 322 described above, but for a second past time period. For example, the configuration and weather data from ten days ago may be used by the ANN 102 via the model 320 to predict the runway configurations from nine days ago. This prediction can then be compared to what the runway configurations actually were nine days ago. The past runway configuration predictions and the past actual runway configurations can be compared with each other to identify differences.

Feedback can be provided to the ANN 102 in the form of a calculated error or other indication of the differences between the past runway configuration predictions and the past actual runway configurations. Based on this error, the neurons 406 can change one or more of the synaptic circuits 414 that connect the neurons 406, the weights applied by one or more of the neurons 406, and/or the mathematical relationships between the neurons 406. For example, some synaptic circuits 414 can be changed to modified synaptic circuits 414′ such that the same input 416 would result in different neurons 406 receiving input and passing output to other neurons and generating a different output 418′ from the ANN 102.

After training the ANN 102, the ANN 102 can use the trained model 320 to predict runway configurations. During post-training iterations of operation of the ANN 102, additional feedback can be provided to the ANN 102 based on differences between the predicted runway configurations 322 and the actual runway configurations that occurred. For example, after training, the ANN 102 can receive the weather predictions, airport constraints, etc., and predict the runway configurations 322 for a forward prediction window. As time progresses into the forward prediction window, the actual runway configurations can be compared to the predicted runway configurations 322 and differences (e.g., errors) can be identified. These differences can again be input into the ANN 102 to continue to change the synaptic circuits 414, 414', neurons 406, mathematical relationships, etc. to further refine and improve the model 320 for use in continuing to increase the accuracy and precision of the predicted runway configurations 322. For example, the ANN 102 may be trained and re-trained using backpropagation, which can involve adjusting model parameters (e.g., synaptic circuits 414 and/or weights) using calculated derivatives to minimize the loss function (e.g., the error). The backpropagation can be a mathematical calculation for supervised learning of the ANN 102 using gradient descent. Backpropagation can be used to calculate the gradient of the error function with respect to the weights of the ANN 102.

The ANN 102 and model 320 can be airport agnostic. For example, different ANNs 102 can train different models 320 for predicting runway configurations of different airports. The ANN 102 and model 320 need not be specific to any particular airport, runway layout, or the like.

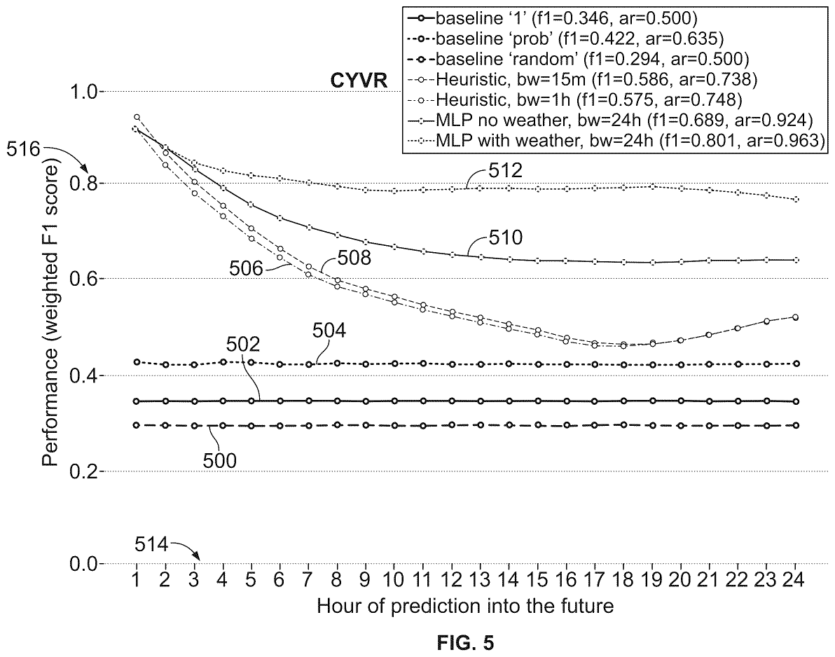

FIG. 5 illustrates performance metrics 500, 502, 504, 506, 508, 510, 512 of different prediction models for predicting runway configurations. The performance metrics 500, 502, 504, 506, 508, 510, 512 are shown alongside a horizontal axis 514 representative of future time and a vertical axis 516 representative of weighted F1 scores. The horizontal axis 514 can represent the forward prediction window in which the different models predicted the runway configurations. The performance metric 500 represents the weighted F1 scores for the different models predicting runway configurations at different times into the future. The metrics 500 represent the weighted F1 scores for a model that randomly selects the runway configurations. The metrics 502 represent the weighted F1 scores for another model that assumes that the runway configurations do not change. The metrics 504 represent the weighted F1 scores for a probabilistic model used to predict runway configurations. The metrics 506, 508 represent weighted F1 scores for heuristic models used to predict the runway configurations.

The metric 510 represents the weighted F1 scores for the ANN 102 that does not use or consider the forecasted weather conditions in predicting runway configurations. The metric 512 represents the weighted F1 scores for the ANN 102 that does consider the forecasted weather conditions in predicting runway configurations, as described above. As shown in FIG. 5, the ANN 102 described above provides the highest weighted F1 scores among all models across all of the forward prediction window but for the first hour of this window. This indicates the improved accuracy of the examples of the ANN 102 described herein. The encoding of the historical runway configurations, the weather forecast, and the predicted runway configurations as described herein increases the accuracy of the runway configurations over the extended prediction window over and above the other models.

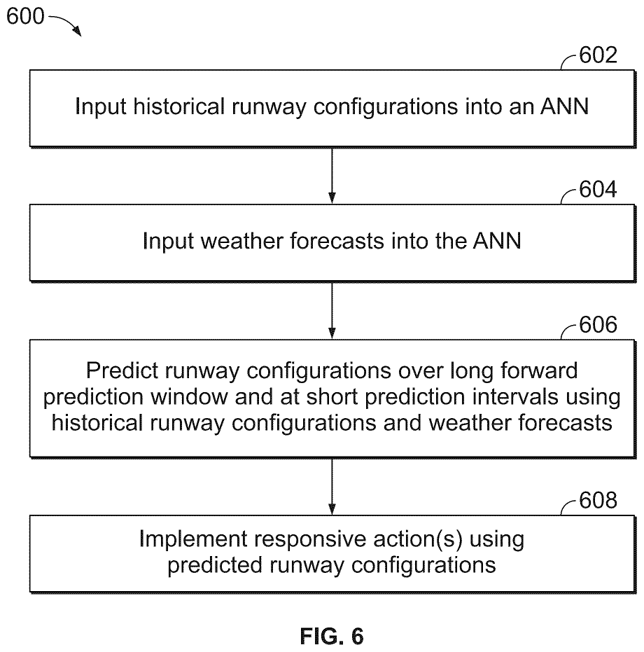

FIG. 6 illustrates a flowchart of one example of a method 600 for predicting runway configurations. The method 600 can represent operations performed by the ANN 102 described herein. At 602, historical runway configurations for an airport are input into an ANN. Optionally, past weather conditions at the airport for the same dates and times that the historical runway configurations were recorded can be obtained and input into the ANN. Additionally, airport constraints may be obtained and input into the ANN.

At 604, weather forecasts for the airport are obtained and input into the ANN. These weather forecasts can be for a forward prediction window that is significantly longer than some known prediction models, such as by being longer than twelve hours, longer than sixteen hours, or the like. At 606, the weather forecasts and historical runway configurations (and, optionally, airport constraints and/or past weather conditions) are used by the ANN to predict the runway configurations over the forward prediction window. The runway configurations may be predicted for prediction intervals in the forward prediction window. The prediction intervals may be short, such as less than sixty minutes, less than forty-five minutes, less than thirty minutes, or no more than fifteen minutes in different examples. At 608, the runway configuration predictions are used to implement one or more responsive actions. For example, schedules of one or more aircraft may be modified based on the predicted runway configurations, flight paths of one or more aircraft may be modified, and so on. Flow of the method 600 can repeat one or more times to continue predicting the runway configurations. For example, the method 600 can be repeated at least once every prediction interval to continue extending the forward prediction window.

Further, the disclosure comprises examples according to the following clauses:

Clause 1: An application-specific integrated circuit (ASIC) for an artificial neural network (ANN), the ASIC comprising: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to:

receive historical configurations of runways for an airport; receive weather forecasts for the airport over an extended forward prediction window; and predict future configurations of the runways for each of several prediction intervals within the forward prediction window and over an entirety of the forward prediction window.

Clause 2: The ASIC of Clause 1, wherein the historical configurations and the future configurations of the runways include one or more of arrival or departure configurations of the runways, directions of aircraft movement on the runways, or active or inactive configurations of the runways.

Clause 3: The ASIC of Clause 1, wherein the historical configurations of the runways are received for each of the prediction intervals within a previous time window before the forward prediction window.

Clause 4: The ASIC of Clause 1, wherein the forward prediction window is at least twenty-four hours.

Clause 5: The ASIC of Clause 1, wherein the prediction intervals are no longer than forty-five minutes, or no longer than sixty minutes.

Clause 6: The ASIC of Clause 1, wherein the processing elements of the neurons are configured to encode the historical runway configurations into sets, with each of the sets including the historical runway configuration for the corresponding runway divided into the prediction intervals and into separate indications of whether the corresponding runway was configured for aircraft arrival or aircraft departure.

Clause 7: The ASIC of Clause 1, wherein the processing elements of the neurons are configured to encode the weather forecasts into sets, with each of the sets including the weather forecast from a source of the weather forecast divided into a wind direction and a wind speed.

Clause 8: A method comprising: receiving historical configurations of runways for an airport into an artificial neural network (ANN) having at least one application-specific integrated circuit (ASIC) having neurons organized in an array, each of the neurons including a register, a processing element, and at least one input, and the ASIC having synaptic circuits, each of the synaptic circuits including a memory for storing a synaptic weight, wherein each of the neurons is connected to at least one other of the neurons via at least one of the synaptic circuits; receiving weather forecasts for the airport over an extended forward prediction window into the ANN; and using the ANN to predict future configurations of the runways for each of several prediction intervals within the forward prediction window and over an entirety of the forward prediction window.

Clause 9: The method of Clause 8, wherein the historical configurations and the future configurations of the runways include one or more of arrival or departure configurations of the runways, directions of aircraft movement on the runways, or active or inactive configurations of the runways.

Clause 10: The method of Clause 8, wherein the historical configurations of the runways are received for each of the prediction intervals within a previous time window before the forward prediction window.

Clause 11: The method of Clause 8, wherein the forward prediction window is at least twenty-four hours.

Clause 12: The method of Clause 8, wherein the prediction intervals are no longer than forty-five minutes, or no longer than sixty minutes.

Clause 13: The method of Clause 8, further comprising: encoding the historical runway configurations into sets, with each of the sets including the historical runway configuration for the corresponding runway divided into the prediction intervals and into separate indications of whether the corresponding runway was configured for aircraft arrival or aircraft departure.

Clause 14: The method of Clause 8, further comprising: encoding the weather forecasts into sets, with each of the sets including the weather forecast from a source of the weather forecast divided into a wind direction and a wind speed.

Clause 15: An application-specific integrated circuit (ASIC) for an artificial neural network (ANN), the ASIC comprising: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive historical configurations of runways for an airport; receive airport constraints on usage of the runways; receive weather forecasts for the airport over an extended forward prediction window of longer than twelve hours; and predict future configurations of the runways for each of several prediction intervals that are less than forty-five minutes and within the forward prediction window and over an entirety of the forward prediction window.

Clause 16: The ASIC of Clause 15, wherein the historical configurations and the future configurations of the runways include one or more of arrival or departure configurations of the runways, directions of aircraft movement on the runways, or active or inactive configurations of the runways.

Clause 17: The ASIC of Clause 15, wherein the historical configurations of the runways are received for each of the prediction intervals within a previous time window before the forward prediction window.

Clause 18: The ASIC of Clause 15, wherein the airport constraints include a number of personnel available at the airport.

Clause 19: The ASIC of Clause 15, wherein the processing elements of the neurons are configured to encode the historical runway configurations into sets, with each of the sets including the historical runway configuration for the corresponding runway divided into the prediction intervals and into separate indications of whether the corresponding runway was configured for aircraft arrival or aircraft departure.

Clause 20: The ASIC of Clause 15, wherein the processing elements of the neurons are configured to encode the weather forecasts into sets, with each of the sets including the weather forecast from a source of the weather forecast divided into a wind direction and a wind speed.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An application-specific integrated circuit (ASIC) for an artificial neural network (ANN), the ASIC comprising:
neurons organized in an array, each of the neurons including a register, a processing element, and at least one input; and
synaptic circuits, each of the synaptic circuits including a memory for storing a synaptic weight, wherein each of the neurons is connected to at least one other of the neurons via at least one of the synaptic circuits, the processing elements of the neurons configured to:
receive historical configurations of runways for an airport;
receive weather forecasts for the airport over an extended forward prediction window; and
predict future configurations of the runways for each of several prediction intervals within the forward prediction window and over an entirety of the forward prediction window.

2. The ASIC of claim 1, wherein the historical configurations and the future configurations of the runways include one or more of arrival or departure configurations of the runways, directions of aircraft movement on the runways, or active or inactive configurations of the runways.

3. The ASIC of claim 1, wherein the historical configurations of the runways are received for each of the prediction intervals within a previous time window before the forward prediction window.

4. The ASIC of claim 1, wherein the forward prediction window is at least twenty-four hours.

5. The ASIC of claim 1, wherein the prediction intervals are no longer than sixty minutes.

6. The ASIC of claim 1, wherein the processing elements of the neurons are configured to encode the historical runway configurations into sets, with each of the sets including the historical runway configuration for the corresponding runway divided into the prediction intervals and into separate indications of whether the corresponding runway was configured for aircraft arrival or aircraft departure.

7. The ASIC of claim 1, wherein the processing elements of the neurons are configured to encode the weather forecasts into sets, with each of the sets including the weather forecast from a source of the weather forecast divided into a wind direction and a wind speed.

8. A method comprising:
receiving historical configurations of runways for an airport into an artificial neural network (ANN) having at least one application-specific integrated circuit (ASIC) having neurons organized in an array, each of the neurons including a register, a processing element, and at least one input, and the ASIC having synaptic circuits, each of the synaptic circuits including a memory for storing a synaptic weight, wherein each of the neurons is connected to at least one other of the neurons via at least one of the synaptic circuits;
receiving weather forecasts for the airport over an extended forward prediction window into the ANN; and
using the ANN to predict future configurations of the runways for each of several prediction intervals within the forward prediction window and over an entirety of the forward prediction window.

9. The method of claim 8, wherein the historical configurations and the future configurations of the runways include one or more of arrival or departure configurations of the runways, directions of aircraft movement on the runways, or active or inactive configurations of the runways.

10. The method of claim 8, wherein the historical configurations of the runways are received for each of the prediction intervals within a previous time window before the forward prediction window.

11. The method of claim 8, wherein the forward prediction window is at least twenty-four hours.

12. The method of claim 8, wherein the prediction intervals are no longer than sixty minutes.

13. The method of claim 8, further comprising:
encoding the historical runway configurations into sets, with each of the sets including the historical runway configuration for the corresponding runway divided into the prediction intervals and into separate indications of whether the corresponding runway was configured for aircraft arrival or aircraft departure.

14. The method of claim 8, further comprising:
encoding the weather forecasts into sets, with each of the sets including the weather forecast from a source of the weather forecast divided into a wind direction and a wind speed.

15. An application-specific integrated circuit (ASIC) for an artificial neural network (ANN), the ASIC comprising:
neurons organized in an array, each of the neurons including a register, a processing element, and at least one input; and
synaptic circuits, each of the synaptic circuits including a memory for storing a synaptic weight, wherein each of the neurons is connected to at least one other of the neurons via at least one of the synaptic circuits, the processing elements of the neurons configured to:
receive historical configurations of runways for an airport;
receive airport constraints on usage of the runways;
receive weather forecasts for the airport over an extended forward prediction window of longer than twelve hours; and
predict future configurations of the runways for each of several prediction intervals that are less than sixty minutes and within the forward prediction window and over an entirety of the forward prediction window.

16. The ASIC of claim 15, wherein the historical configurations and the future configurations of the runways include one or more of arrival or departure configurations of the runways, directions of aircraft movement on the runways, or active or inactive configurations of the runways.

17. The ASIC of claim 15, wherein the historical configurations of the runways are received for each of the prediction intervals within a previous time window before the forward prediction window.

18. The ASIC of claim 15, wherein the airport constraints include a number of personnel available at the airport.

19. The ASIC of claim 15, wherein the processing elements of the neurons are configured to encode the historical runway configurations into sets, with each of the sets including the historical runway configuration for the corresponding runway divided into the prediction intervals and into separate indications of whether the corresponding runway was configured for aircraft arrival or aircraft departure.

20. The ASIC of claim 15, wherein the processing elements of the neurons are configured to encode the weather forecasts into sets, with each of the sets including the weather forecast from a source of the weather forecast divided into a wind direction and a wind speed.
